(19) United States
(12) Patent Application Publication
(10) Pub. No.: US 2026/0116686 A1
(43) Pub. Date: Apr. 30, 2026

(54) CONVEYANCE DEVICE AND READING APPARATUS

(71) Applicant: SEIKO EPSON CORPORATION, TOKYO (JP)

(72) Inventor: Makoto Wada, KITAKYUSHU-SHI (JP)

(21) Appl. No.: 19/366,646

(22) Filed: Oct. 23, 2025

(30) Foreign Application Priority Data
Oct. 25, 2024 (JP) 2024-188054

(51) Int. Cl. B65H 7/06; B65H 3/06

(52) U.S. Cl. CPC B65H 7/06; B65H 3/06; B65H 2801/39

(57) ABSTRACT

According to an aspect of the present disclosure, there is provided a conveyance device including a supply tray on which a plurality of documents are stacked, a supply roller configured to come into contact with an uppermost document among the plurality of documents stacked on the supply tray, a separation roller facing the supply roller and configured to separate, one by one, the plurality of documents stacked on the supply tray, and a control unit configured to acquire imaging data obtained by imaging the uppermost document stacked on the supply tray. The control unit analyzes the imaging data to thereby determine whether the uppermost document is a document bound with another document and, when determining that the uppermost document is the document bound with another document, stops the supply roller.

The present application is based on, and claims priority from JP Application Serial Number 2024-188054, filed October 25, 2024, the disclosure of which is hereby incorporated by reference herein in its entirety.

### BACKGROUND

### 1. Technical Field

The present disclosure relates to a conveyance device and a reading apparatus.

### 2. Related Art

JP-A-2004-182449 describes a reading apparatus that conveys, one by one, a plurality of documents stacked on a supply tray to thereby sequentially read the documents. The reading apparatus includes a detection sensor that detects jumping of the documents stacked on the supply tray. The reading apparatus detects, with the detection sensor, the documents bound in a bundle shape. In this case, the reading apparatus protects the documents, the apparatus, and the like by stopping the conveyance of the documents.

JP-A-2004-182449 is an example of the related art.

The reading apparatus explained above, the detection sensor sometimes erroneously detects the documents. Since the detection sensor detects the jumping of the documents, the detection sensor is likely to detect the documents even when the documents are not bound in a bundle shape.

### SUMMARY

According to an aspect of the present disclosure, there is provided a conveyance device including: a supply tray on which a plurality of documents are stacked; a supply roller configured to come into contact with an uppermost document among the plurality of documents stacked on the supply tray; a separation roller facing the supply roller and configured to separate, one by one, the plurality of documents stacked on the supply tray; and a control unit configured to acquire imaging data obtained by imaging the uppermost document stacked on the supply tray, wherein the control unit analyzes the imaging data to thereby determine whether the uppermost document is a document bound with another document and, when determining that the uppermost document is the document bound with another document, stops the supply roller.

According to another aspect of the present disclosure, there is provided a reading apparatus including: the conveyance device; and a reading unit configured to read the plurality of documents.

### BRIEF DESCRIPTION OF THE DRAWINGS

FIG. 1 is a diagram illustrating an example of a reading apparatus including a conveyance device.

FIG. 2 is a diagram illustrating an example of imaging data captured before the start of conveyance.

FIG. 3 is a diagram illustrating an example of imaging data captured after the start of conveyance.

FIG. 4 is a diagram illustrating another example of the imaging data captured after the start of conveyance.

FIG. 5 is a diagram illustrating an example of imaging data captured after the start of conveyance different from the examples illustrated in FIGS. 3 and 4.

FIG. 6 is a flowchart illustrating an example of conveyance processing.

FIG. 7 is a flowchart illustrating an example of adjustment processing.

FIG. 8 is a flowchart illustrating an example of analysis processing.

FIG. 9 is a diagram illustrating an example of imaging data captured after the start of conveyance different from the examples illustrated in FIGS. 3, 4, and 5.

### DESCRIPTION OF EMBODIMENTS

Hereinafter, an example of a reading apparatus including a conveyance device is explained with reference to the drawings. The reading apparatus is, for example, a sheet-feed type scanner that reads an image recorded on a document such as paper or a film conveyed by a conveyance device.

### Reading apparatus

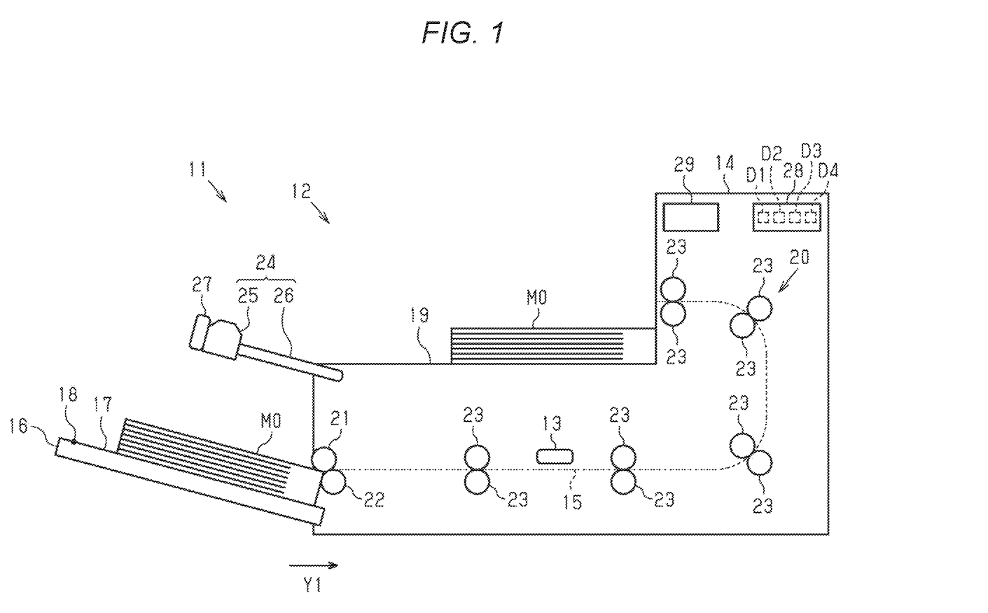

As illustrated in FIG. 1, a reading apparatus 11 includes a conveyance device 12. The conveyance device 12 is configured to convey a document M0. Specifically, the conveyance device 12 is configured to convey a plurality of documents M0 one by one.

The reading apparatus 11 includes a reading unit 13. The reading unit 13 is configured to read the document M0. Specifically, the reading unit 13 is configured to read the plurality of documents M0 conveyed by the conveyance device 12. The reading unit 13 is located in the conveyance device 12. The reading unit 13 reads the document M0 being conveyed by the conveyance device 12. The reading unit 13 reads, one after another, the plurality of documents M0 conveyed by the conveyance device 12. The reading unit 13 may be configured to read one side of the conveyed document M0 or may be configured to read both sides thereof. The reading unit 13 includes an image sensor. The reading unit 13 includes, for example, a CISM. The reading unit 13 may be configured to read the document M0 in a full color or may be configured to read the document M0 in a grayscale.

### Conveyance device

The conveyance device 12 includes a housing 14. In one example, the housing 14 houses the reading unit 13. A conveyance route 15 is formed in the housing 14. The conveyance route 15 is a route on which the document M0 is conveyed. The conveyance route 15 extends in the housing 14. The reading unit 13 is located halfway in the conveyance route 15.

The conveyance device 12 includes a supply tray 16. The supply tray 16 is a tray on which one or more documents M0 are stacked. For example, a plurality of documents M0 are stacked on the supply tray 16. The supply tray 16 is a tray on which the document M0 before reading is stacked. The supply tray 16 extends from, for example, the housing 14. The supply tray 16 extends from the housing 14 to guide the document M0 to the conveyance route 15. In one example, the supply tray 16 extends to incline upward from the housing 14. Accordingly, the document M0 is easily guided from the supply tray 16 to the conveyance route 15.

The supply tray 16 has a stacking surface 17. The stacking surface 17 is a surface on which the document M0 is stacked. The stacking surface 17 is a surface facing upward in the supply tray 16. A reference line 18 may be formed on the stacking surface 17. The reference line 18 may be printed on the stacking surface 17 or may be formed by a groove carved on the stacking surface 17.

The reference line 18 is a line serving as a reference for the document M0 stacked on the supply tray 16. For example, when the reference line 18 and the trailing end of the document M0 are parallel, the document M0 can normally enter the conveyance route 15. When the trailing end of the document M0 is inclined with respect to the reference line 18, the document M0 is likely obliquely enter the conveyance route 15. The reference line 18 is desirably located at a position not overlapping the document M0 on the stacking surface 17.

The conveyance device 12 includes a discharge tray 19. The discharge tray 19 is a tray on which one or more documents M0 are stacked. Specifically, the discharge tray 19 is a tray on which the document M0 after reading is stacked. The discharge tray 19 is located to receive the document M0 discharged from the housing 14 through the conveyance route 15. In one example, the discharge tray 19 is configured by an upper surface of the housing 14.

The conveyance device 12 includes a conveyance unit 20. The conveyance unit 20 is configured to convey the document M0. The conveyance unit 20 conveys the document M0 from the supply tray 16 toward the discharge tray 19. The conveyance unit 20 conveys the document M0 along the conveyance route 15. The conveyance unit 20 conveys a plurality of documents M0 one by one.

The conveyance unit 20 includes a supply roller 21. The supply roller 21 is a roller that supplies the document M0 from the supply tray 16 to the conveyance route 15. The supply roller 21 is located to come into contact with an uppermost document M0 among a plurality of documents M0 stacked on the supply tray 16. The supply roller 21 supplies the uppermost document M0 among the plurality of documents M0 stacked on the supply tray 16 into the housing 14. The supply roller 21 sequentially conveys, in a conveyance direction Y1, the plurality of documents M0 stacked on the supply tray 16.

The conveyance unit 20 includes a separation roller 22. The separation roller 22 is located to face the supply roller 21. The separation roller 22 is located to hold the document M0 between the separation roller 22 and the supply roller 21. The separation roller 22 is a roller that separates, one by one, the plurality of documents M0 stacked on the supply tray 16. The separation roller 22 is, for example, a roller to which torque is applied in a direction in which the document M0 is returned from the conveyance route 15 toward the supply tray 16. In this case, when the plurality of documents M0 enter between the supply roller 21 and the separation roller 22, the document M0 in contact with the supply roller 21 is sent to the conveyance route 15 and, on the other hand, the document M0 in contact with the separation roller 22 is returned to the supply tray 16. Accordingly, the documents M0 are conveyed from the supply tray 16 one by one.

The conveyance unit 20 includes one or more conveyance rollers 23. In one example, the conveyance unit 20 includes a plurality of conveyance rollers 23. The conveyance roller 23 is a roller that conveys the document M0 along the conveyance route 15. The conveyance roller 23 conveys the document M0 supplied into the housing 14 toward the discharge tray 19.

The conveyance device 12 may include an imaging unit 24. The imaging unit 24 is located to face the supply tray 16. The imaging unit 24 is located above the supply tray 16. The imaging unit 24 is located to image the document M0 stacked on the supply tray 16. The imaging unit 24 is located to image at least the uppermost document M0 among the plurality of documents M0 stacked on the supply tray 16.

The imaging unit 24 images the document M0 to thereby generate imaging data D1. The imaging data D1 is image data obtained by imaging the document M0 stacked on the supply tray 16. Specifically, the imaging data D1 is image data obtained by imaging at least the uppermost document M0 among the plurality of documents M0 stacked on the supply tray 16. The imaging data D1 may be full color image data or grayscale image data.

The imaging unit 24 is located such that at least the trailing end of the document M0 is imaged. The imaging unit 24 may be located such that the leading end of the document M0 is imaged. For example, the imaging unit 24 may image the document M0 such that the entire document M0 is imaged from the leading end to the trailing end of the document M0.

The imaging unit 24 is attached to the housing 14. The imaging unit 24 extends from the housing 14 toward right above the supply tray 16. The imaging unit 24 may be configured to be capable of being housed in the housing 14.

The imaging unit 24 may include an imaging portion 25. The imaging portion 25 is configured to image the document M0. The imaging portion 25 includes, for example, a camera. The imaging unit 24 may include a support portion 26. The support portion 26 is configured to support the imaging portion 25. The support portion 26 extends from the housing 14. The support portion 26 is, for example, an arm.

The imaging unit 24 may be configured to be capable of adjusting the position thereof. The imaging unit 24 may be configured to adjust the position of the imaging portion 25 by, for example, moving the support portion 26. The imaging unit 24 may be configured such that the user manually adjusts the position thereof or may be configured to automatically adjust the position thereof. Accordingly, the imaging unit 24 can appropriately image the document M0 stacked on the supply tray 16.

The conveyance device 12 may be configured such that an imaging device different from the reading apparatus 11 and the conveyance device 12 can be attached thereto. The imaging device may be, for example, a smartphone or a handy camera owned by a user. An imaging device may be attached to the conveyance device 12 such that the imaging device can image the document M0 stacked on the supply tray 16. The conveyance device 12 may include, for example, a pedestal on which the imaging device can be installed, an attachment arm, and the like.

The conveyance device 12 may include an irradiation unit 27. The irradiation unit 27 is configured to emit light toward the supply tray 16. The irradiation unit 27 is located to face the supply tray 16. The irradiation unit 27 irradiates the document M0 stacked on the supply tray 16 with light. Accordingly, the imaging unit 24 can easily image the document M0.

The irradiation unit 27 may be attached to the imaging unit 24. The position of the irradiation unit 27 may be adjusted as the position of the imaging unit 24 is adjusted. The irradiation unit 27 may be configured to be capable of adjusting the position thereof independently of the imaging unit 24. In this case, the irradiation unit 27 may be attached to the housing 14 independently of the imaging unit 24. The irradiation unit 27 may be configured to be housed in the housing 14.

The irradiation unit 27 may be configured to be capable of adjusting a light amount. The irradiation unit 27 may be configured to automatically adjust the light amount or may be configured such that the user manually adjusts the light amount. The irradiation unit 27 adjusts the light amount such that the document M0 is appropriately images in the imaging data D1. The irradiation unit 27 may adjust the light amount such that the document M0 and the supply tray 16 are easily identified in the imaging data D1. The irradiation unit 27 may adjust the light amount such that an edge of the document M0 is emphasized in the imaging data D1. The irradiation unit 27 may adjust the light amount based on a state of imaging of an adjustment object formed on the supply tray 16.

The conveyance device 12 may include a storage unit 28. The storage unit 28 is configured to store one or more programs. The storage unit 28 stores a program for causing the conveyance device 12 to convey the document M0. The storage unit 28 may store a program for causing the reading apparatus 11 to read the document M0. The storage unit 28 includes memories such as a ROM and a RAM. The storage unit 28 may include a storage medium such as a HDD or an SSD.

Besides the programs, the storage unit 28 may store data used at the times of conveyance, reading, and the like. The storage unit 28 stores the imaging data D1. The storage unit 28 stores, for example, the imaging data D1 generated by the imaging unit 24. The storage unit 28 may store the imaging data D1 transmitted from an external device different from the reading apparatus 11 and the conveyance device 12.

The storage unit 28 may store one or more thresholds D2. The threshold D2 is a numerical value used to determine whether the uppermost document M0 is a bound document M0. Specifically, the threshold D2 is a value compared with a tilt at the trailing end of the document M0. The storage unit 28 may store the threshold D2 for each size of the document M0 or may store the threshold D2 for each type of the document M0.

The storage unit 28 may store a pattern image D3. The pattern image D3 is an image used to determine whether the uppermost document M0 is the bound document M0. Specifically, the pattern image D3 is an image used for pattern matching for the imaging data D1.

The storage unit 28 may store a machine-learned model D4. The model D4 is configured to output, based on the imaging data D1, a determination value indicating whether the uppermost document M0 is the bound document M0. In one example, the model D4 is configured to output the determination value when the imaging data D1 is input. The model D4 may be configured to output the determination value when a parameter indicating a feature value included in the imaging data D1 is input. The determination value includes, for example, a value indicating that the uppermost document M0 is the bound document M0 and a value indicating that the uppermost document M0 is not the bound document M0.

The model D4 is generated by training a machine learning model with learning data. The machine learning model learns, based on the learning data, a correspondence relationship between input parameters and output parameters. Accordingly, the model D4 that is mapping data of the input parameters and the output parameters is generated. A learning method may be supervised learning by a neural network or may be another method. The learning method may be deep learning. The learning data may be the imaging data D1 in which the bound document M0 is imaged, may be the imaging data D1 in which an unbound document M0 is imaged, or may be both of the imaging data D1. The machine learning model is trained by the learning data explained above, whereby the model D4 for classifying the document M0 imaged in the imaging data D1 into the bound document M0 or the unbound document M0 is generated.

The conveyance device 12 may include a control unit 29. The control unit 29 is configured to execute processing according to a program stored in the storage unit 28. The control unit 29 includes a processor such as a CPU, a GPU, or a TPU. The control unit 29 may include not only the processor but also a hardware circuit such as an ASIC. In this way, the control unit 29 implements a computer in conjunction with the storage unit 28. Therefore, the conveyance device 12 includes the computer.

The control unit 29 is configured to comprehensively control the conveyance device 12. The control unit 29 may control the reading unit 13. The control unit 29 may be configured to comprehensively control the reading apparatus 11.

The control unit 29 is configured to acquire the imaging data D1. In one example, the control unit 29 acquires the imaging data D1 from the imaging unit 24. The control unit 29 may acquire the imaging data D1 from the imaging device. The control unit 29 may acquire the imaging data D1 from the imaging device by communicating with the imaging device. The control unit 29 may acquire the imaging data D1 stored in an external computer. The control unit 29 causes the storage unit 28 to store the acquired imaging data D1. The control unit 29 acquires the imaging data D1 after the supply start. The control unit 29 may acquire the imaging data D1 before the supply start besides the imaging data D1 after the supply start.

The control unit 29 is configured to analyze the imaging data D1. The control unit 29 may analyze the imaging data D1 by applying image processing to the imaging data D1 according to a program. The control unit 29 may analyze the imaging data D1 by applying contrast adjustment, applying pixel conversion, applying noise removal, or applying edge enhancement to the imaging data D1. The control unit 29 may analyze the imaging data D1 by, for example, detecting an edge of the document M0. The control unit 29 may analyze the imaging data D1 by extracting a feature value from the imaging data D1 and inputting the feature value to the model D4. The control unit 29 may analyze the imaging data D1 by inputting the imaging data D1 to the model D4. The control unit 29 analyzes the imaging data D1 after the supply start. The control unit 29 may analyze the imaging data D1 before the supply start.

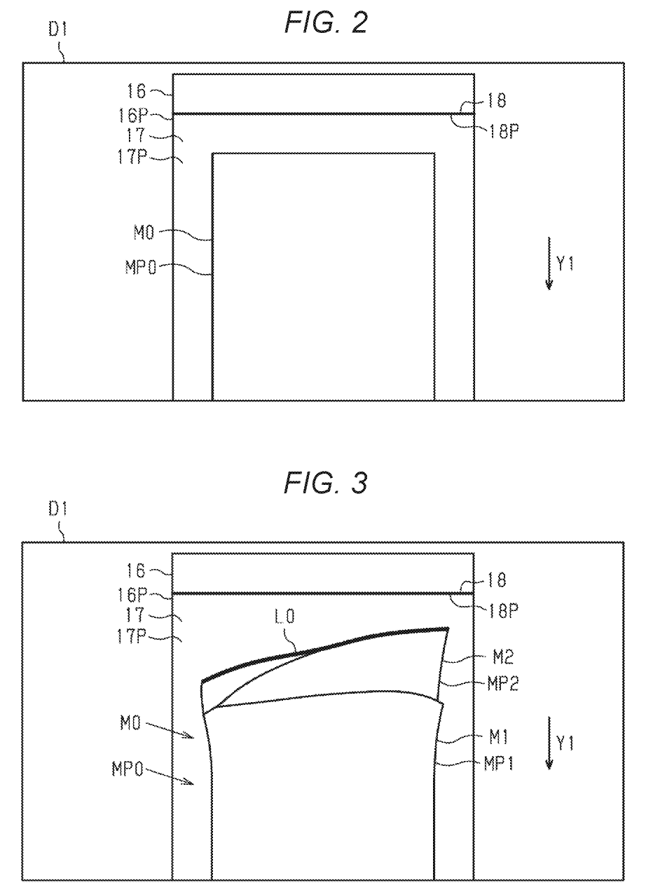

As illustrated in FIG. 2, the imaging data D1 before the supply start indicates the document M0 stacked on the supply tray 16. Specifically, the imaging data D1 before the supply start indicates the uppermost document M0 among the plurality of documents M0. The document M0 is indicated by a document pixel MP0 in the imaging data D1. The document pixel MP0 is a pixel indicating the document M0 in the imaging data D1. The imaging data D1 indicates a supply tray pixel 16P, a stacking surface pixel 17P, a reference line pixel 18P, and the like besides the document pixel MP0. The supply tray pixel 16P is a pixel indicating the supply tray 16 in the imaging data D1. The stacking surface pixel 17P is a pixel indicating the stacking surface 17 in the supply tray pixel 16P. The reference line pixel 18P is a pixel indicating the reference line 18 in the supply tray pixel 16P.

The control unit 29 may adjust the position of the imaging unit 24 based on the imaging data D1 before the supply start. The control unit 29 may adjust the position of the imaging unit 24 by analyzing the imaging data D1 before the supply start. For example, the control unit 29 may automatically adjust the position of the imaging unit 24. The control unit 29 may adjust the position of the imaging unit 24 by, for example, causing a screen such as an operation panel to display a message for urging the user to adjust the imaging unit 24. The control unit 29 adjusts the position of the imaging unit 24 such that the document M0 is appropriately imaged.

The control unit 29 may adjust the position, the light amount, and the like of the irradiation unit 27 based on the imaging data D1 before the supply start. The control unit 29 may adjust the position, the light amount, and the like of the irradiation unit 27 by analyzing the imaging data D1 before the supply start. For example, the control unit 29 may automatically adjust the position, the light amount, and the like of the irradiation unit 27. The control unit 29 may adjust the position and the light amount of the irradiation unit 27 by, for example, causing the screen to display a message for urging the user to adjust the irradiation unit 27. The control unit 29 adjusts the irradiation unit 27 such that the document M0 is appropriately imaged.

As illustrated in FIGS. 3, 4, and 5, the imaging data D1 after the supply start is data obtained by imaging a first document M1 and a second document M2. The first document M1 is the uppermost document M0 among the plurality of documents M0 stacked on the supply tray 16. The second document M2 is the document M0 next to the first document M1 among the plurality of documents M0 stacked on the supply tray 16. In the imaging data D1 after the supply start, since the first document M1 is conveyed, the second document M2 is imaged. The first document M1 is indicated by a first document pixel MP1 in the imaging data D1. The first document pixel MP1 is a pixel indicating the first document M1 in the document pixel MP0. The second document M2 is indicated by a second document pixel MP2 in the imaging data D1. The second document pixel MP2 is a pixel indicating the second document M2 in the document pixel MP0.

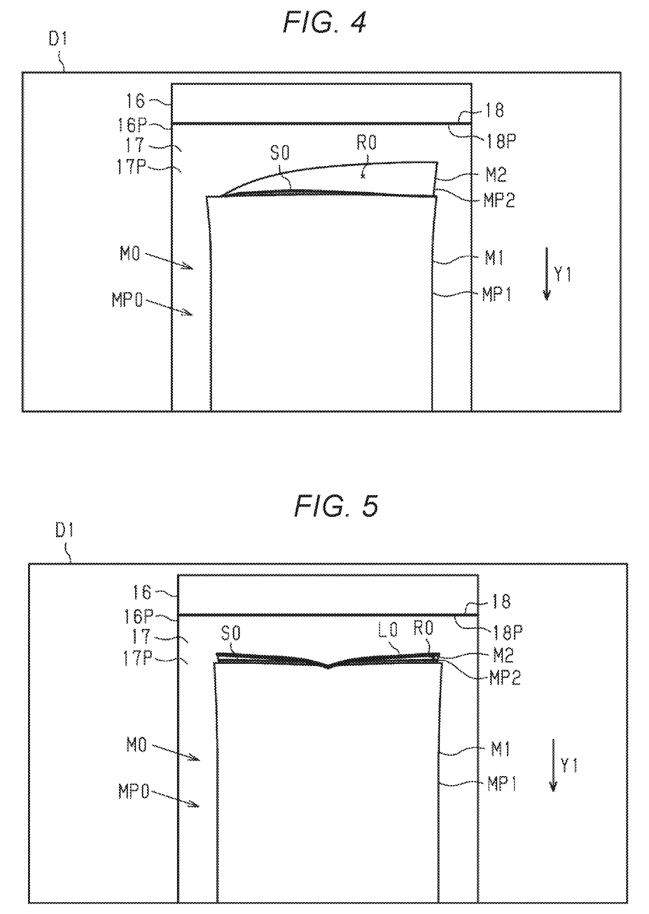

In the conveyance device 12, the bound document M0 is sometimes stacked on the supply tray 16. For example, in the conveyance device 12, the first document M1 and the second document M2 among the plurality of documents M0 are sometimes stacked on the supply tray 16 in a bound state. For example, the first document M1 and the second document M2 bound with each other by a staple are sometimes stacked on the supply tray 16. In the examples illustrated in FIGS. 3, 4, and 5, the trailing ends of the documents M0 are bound. Specifically, in the examples illustrated in FIGS. 3 and 4, the corner portions of the first document M1 and the second document M2 are bound. In the example illustrated in FIG. 5, the central portions of the first document M1 and the second document M2 are bound.

When the trailing ends of the first document M1 and the second document M2 are bound, the trailing end of the first document M1 and the trailing end of the second document M2 float as the first document M1 is conveyed. In the imaging data D1, when the trailing end of the second document M2 floats, the document M0 next to the second document M2 may be imaged or may not be imaged.

The control unit 29 determines, based on the imaging data D1, whether the uppermost document M0 is the bound document M01. Specifically, the control unit 29 determines, based on the imaging data D1 after the supply start, whether the first document M1 is the bound document M0. The control unit 29 analyzes the imaging data D1 to thereby determine whether the first document M1 is the bound document M0.

The control unit 29 may detect a determination line L0 by analyzing the imaging data D1. The determination line L0 is a line indicating an edge of the document M0 in the imaging data D1. The determination line L0 is also considered to be indicated by the document pixel MP0 equivalent to the edge of the document M0 in the imaging data D1. The determination line L0 is, for example, a line indicating an edge of the document M0 located most upstream in the conveyance direction Y1 among the plurality of documents M0 stacked on the supply tray 16. In one example, the determination line L0 is a line indicating an edge of the second document M2. Specifically, the determination line L0 is a line indicating an edge of the trailing end portion of the second document M2.

The control unit 29 detects the determination line L0 by detecting the edge of the document M0. The control unit 29 detects the determination line L0 based on the luminance of a pixel. The control unit 29 may identify the first document M1 and the second document M2 in detecting the determination line L0. In this case, the control unit 29 detects, as the determination line L0, a line located upstream in the conveyance direction Y1 among edges of the second document M2. The control unit 29 may not identify the first document M1 and the second document M2 in detecting the determination line L0. In this case, the control unit 29 detects, as the determination line L0, a line located most upstream in the conveyance direction Y1 among the edges of the document M0.

The control unit 29 may detect the determination line L0 by binarizing the imaging data D1. The control unit 29 may binarize pixels indicating a background color and pixels indicating other than the background color in the imaging data D1. For example, the control unit 29 converts the pixels indicating the background color into black and converts the pixels indicating other than the background color into white. The control unit 29 detects a contour of a region indicated by the white pixels as the edge of the document M0. The control unit 29 detects, as the determination line L0, a line located most upstream in the conveyance direction Y1 in the contour of the region indicated by the white pixels. The control unit 29 may binarize the imaging data D1 after separating the imaging data D1 into R, G, and B. The control unit 29 may detect the determination line L0 with another method.

The control unit 29 may calculate a gradient of the determination line L0. The control unit 29 may calculate the gradient of the determination line L0 by linearizing the determination line L0. The control unit 29 may calculate the gradient of the determination line L0 based on, for example, the binarized imaging data D1. In this case, the control unit 29 detects four corners to be four points for the contour of the region indicated by the white pixels. The control unit 29 calculates, as the gradient of the determination line L0, a gradient of a straight line connecting two corners located upstream in the conveyance direction Y1 among the four corners. The control unit 29 may detect the gradient of the determination line L0 with another method.

The control unit 29 may determine, based on the gradient of the determination line L0, whether the first document M1 is the bound document M0. When the gradient of the determination line L0 exceeds the threshold D2, the control unit 29 may determine that the first document M1 is the bound document M0. For example, when the gradient of the determination line L0 with respect to the reference line 18 exceeds the threshold D2, the control unit 29 may determine that the first document M1 is the bound document M0. When the first document M1 is bound with the second document M2, the trailing end of the second document M2 floats, whereby the determination line L0 tilts with respect to the reference line 18. Therefore, the control unit 29 can determine, based on the imaging data D1, whether the first document M1 is the bound document M0.

The control unit 29 may determine, based on not only the reference line 18 but also a gradient of the determination line L0 with respect to the horizontal line in the imaging data D1, whether the first document M1 is the bound document M0. The control unit 29 may determine, based on the gradient of the determination line L0 with respect to a line indicated by the leading end of the document M0, whether the first document M1 is the bound document M0. For example, the control unit 29 may determine, based on the gradient of the determination line L0 with respect to a straight line connecting two corners located downstream in the conveyance direction Y1 among the four corners detected in the binarized imaging data D1, whether the first document M1 is the bound document M0.

The control unit 29 may detect a shadow S0 by analyzing the imaging data D1. Specifically, the control unit 29 may detect the shadow S0 formed between the first document M1 and the second document M2 by analyzing the imaging data D1. The trailing end of the first document M1 floats, whereby the shadow S0 is formed between the first document M1 and the second document M2. The control unit 29 detects the shadow S0 based on the luminance of a pixel. The shadow S0 is indicated by a pixel having low luminance among the document pixels MP0 in the imaging data D1.

The control unit 29 may determine, based on the shadow S0, whether the first document M1 is the bound document M0. The control unit 29 may determine, based on, for example, the presence or absence of the shadow S0 in the detection region R0, whether the first document M1 is the bound document M0. The detection region R0 is a region surrounded by an edge of the first document M1 and an edge of the second document M2. The detection region R0 is indicated by pixels surrounded by the edge of the first document M1 and the edge of the second document M2 among the document pixels MP0 in the imaging data D1. The control unit 29 detects the detection region R0 by detecting the edge of the first document M1 and the edge of the second document M2. The control unit 29 detects the detection region R0 by identifying the first document M1 and the second document M2. The control unit 29 may determine, based on, for example, the presence or absence of the shadow S0 in a region occupied by the document M0, whether the first document M1 is the bound document M0. In this case, the control unit 29 can detect the shadow S0 between the first document M1 and the second document M2 without identifying the first document M1 and the second document M2.

When detecting the shadow S0, the control unit 29 may determine that the first document M1 is the bound document M0. When the first document M1 is bound with the second document M2, the trailing end of the first document M1 floats as the first document M1 is conveyed. Accordingly, the shadow S0 is formed between the first document M1 and the second document M2. For that reason, when the irradiation unit 27 is emitting light, the shadow S0 tends to clearly appear.

The control unit 29 may determine, based on the shape of the shadow S0, whether the first document M1 is the bound document M0. The control unit 29 may apply pattern matching to the shape of the shadow S0. The control unit 29 may match the pattern image D3 with the imaging data D1. The pattern image D3 is an image indicating the shape of the shadow S0 formed between the first document M1 and the second document M2. When the shadow S0 of the imaging data D1 matches the shadow S0 of the pattern image D3 according to the pattern matching, the control unit 29 may determine that the shadow S0 is formed between the first document M1 and the second document M2. That is, when the shadow S0 of the imaging data D1 matches the shadow S0 of the pattern image D3, the control unit 29 may determine that the shadow S0 has been detected. When the shadow S0 of the imaging data D1 matches the shadow S0 of the pattern image D3, the control unit 29 may determine that the first document M1 is the bound document M0. By considering the shape of the shadow S0, the accuracy of determining whether the uppermost document M0 is the bound document M0 is improved. For example, the likelihood that the control unit 29 erroneously recognizes the image printed on the second document M2 as the shadow S0 is reduced.

The control unit 29 may determine, based on the determination line L0 and the shadow S0, whether the first document M1 is the bound document M0. For example, when the gradient of the determination line L0 exceeds the threshold D2 and the shadow S0 is detected, the control unit 29 may determine that the first document M1 is the bound document M0. For example, when the gradient of the determination line L0 with respect to the reference line 18 exceeds the threshold D2 and the shadow S0 of the imaging data D1 matches the shadow S0 of the pattern image D3, the control unit 29 may determine that the first document M1 is the bound document M0.

When determining that the first document M1 is the bound document M0, the control unit 29 stops the conveyance of the document M0. Specifically, when determining that the first document M1 is the bound document M0, the control unit 29 stops the supply roller 21. At this time, the control unit 29 may notify the user that the first document M1 is the bound document M0. Since the control unit 29 determines, immediately after the supply is started, whether the first document M1 is the bound document M0, the control unit 29 can stop the conveyance early. Accordingly, when the conveyance of the document M0 is stopped, the user can easily take out the document M0 from the housing 14. In addition, since the conveyance is stopped early, damage to the conveyance device 12 caused by conveying the bound document M0 is reduced.

### Conveyance processing

Subsequently, an example of the conveyance processing is explained. The conveyance processing is processing of conveying the document M0. In one example, the conveyance processing includes processing of reading the conveyed document M0. The conveyance processing is executed by the control unit 29 processing a program stored in the storage unit 28. The conveyance processing is started by, for example, receiving an instruction to start reading from the user.

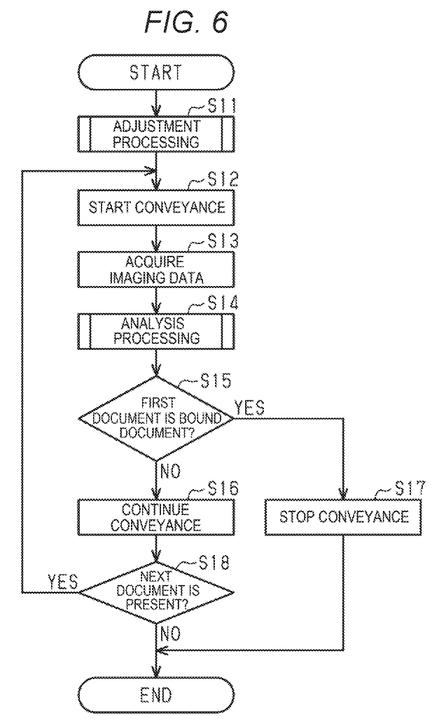

As illustrated in FIG. 6, the control unit 29 may execute adjustment processing in step S11. The adjustment processing may include processing of adjusting the imaging unit 24. The adjustment processing may include processing of adjusting the irradiation unit 27.

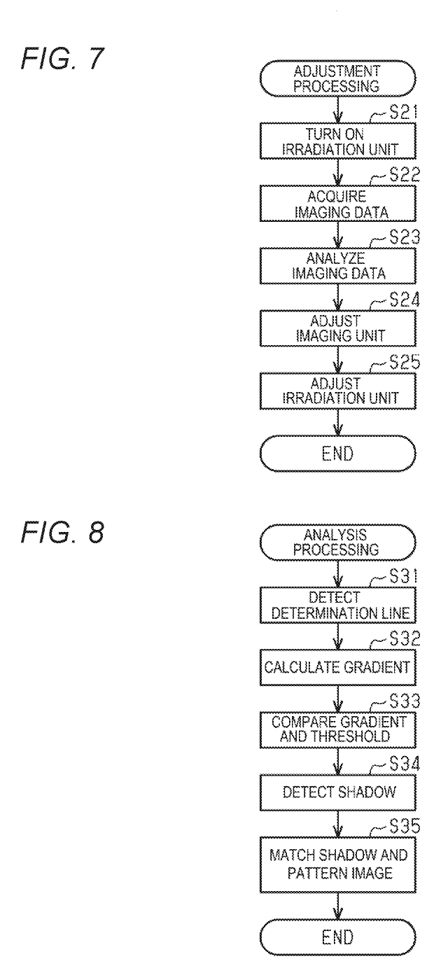

As illustrated in FIG. 7, when executing the adjustment processing, in step S21, the control unit 29 turns on the irradiation unit 27.

In step S22, the control unit 29 acquires the imaging data D1. In one example, the control unit 29 acquires the imaging data D1 from the imaging unit 24. At this time, the control unit 29 acquires the imaging data D1 before the supply start.

In step S23, the control unit 29 analyzes the imaging data D1. At this time, the control unit 29 analyzes the imaging data D1 acquired in step S22. The control unit 29 analyzes the imaging data D1 to thereby determine whether the imaging data D1 is an image in which the supply tray 16 and the document M0 are easily identified. That is, the control unit 29 determines whether the document M0 is clear in the imaging data D1.

In step S24, the control unit 29 may adjust the imaging unit 24 based on the imaging data D1. That is, the control unit 29 adjusts the position of the imaging unit 24 such that the document M0 is clearly imaged. When the document M0 is clear, the control unit 29 may skip the processing in step S24.

In step S25, the control unit 29 may adjust the irradiation unit 27 based on the imaging data D1. That is, the control unit 29 adjusts the position, the light amount, and the like of the irradiation unit 27 such that the document M0 is clearly imaged. When the document M0 is clear, the control unit 29 may skip the processing in step S25.

The control unit 29 may acquire the imaging data D1 again after ending the processing in step S25. The control unit 29 may check, by acquiring the imaging data D1 again, whether the imaging unit 24, the irradiation unit 27, and the like have been appropriately adjusted. When the adjustment is insufficient, the control unit 29 may adjust the imaging unit 24, the irradiation unit 27, and the like again. When ending the adjustment processing, the control unit 29 shifts the processing to step S12.

As illustrated in FIG. 6, in step S12, the control unit 29 starts conveying the document M0. At this time, the control unit 29 starts conveying the first document M1 by rotating the supply roller 21.

In step S13, the control unit 29 acquires the imaging data D1. In one example, the control unit 29 acquires the imaging data D1 from the imaging unit 24. At this time, the control unit 29 acquires the imaging data D1 after the supply start.

In step S14, the control unit 29 executes analysis processing. The analysis processing is processing of analyzing the imaging data D1. In one example, the control unit 29 analyzes the imaging data D1 by applying image processing to the imaging data D1.

As illustrated in FIG. 8, when executing the analysis processing, the control unit 29 may detect the determination line L0 in step S31.

In step S32, the control unit 29 may calculate the gradient of the determination line L0.

In step S33, the control unit 29 may compare the gradient of the determination line L0 with the threshold D2.

In step S34, the control unit 29 may detect the shadow S0.

In step S35, the control unit 29 may match the shadow S0 and the pattern image D3.

The control unit 29 detects both of the determination line L0 and the shadow S0 in the analysis processing but is not limited thereto. In the analysis processing, the control unit 29 may detect only the determination line L0 or may detect only the shadow S0. In the analysis processing, the control unit 29 may acquire a determination value by inputting the imaging data D1 to the model D4. In the analysis processing, the control unit 29 may acquire the determination value by extracting feature values of the edge of the document M0, the shadow S0, and the like from the imaging data D1 and inputting the feature values to the model D4. When ending the analysis processing, the control unit 29 shifts the processing to step S15.

As illustrated in FIG. 6, in step S15, the control unit 29 determines, based on the result of the analysis processing, whether the first document M1 is the bound document M0. In one example, when the gradient of the determination line L0 exceeds the threshold D2 and the shadow S0 is detected, the control unit 29 determines that the first document M1 is the bound document M0. When the gradient of the determination line L0 exceeds the threshold D2, the control unit 29 may determine that the first document M1 is the bound document M0. When detecting the shadow S0, the control unit 29 may determine that the first document M1 is the bound document M0. When the shadow S0 matches the pattern image D3, the control unit 29 may determine that the first document M1 is the bound document M0. When the determination value indicates that the first document M1 is the bound document M0, the control unit 29 may determine that the first document M1 is the bound document M0. When determining in step S15 that the first document M1 is not the bound document M0, the control unit 29 shifts the processing to step S16. When determining in step S15 that the first document M1 is the bound document M0, the control unit 29 shifts the processing to step S17.

In step S16, the control unit 29 continues to convey the document M0. The control unit 29 guides the first document M1 into the housing 14 by continuing the rotation of the supply roller 21. The control unit 29 starts the rotation of the conveyance roller 23. The control unit 29 causes the reading unit 13 to read the first document M1.

In step S18, the control unit 29 determines whether the next document M0 is present on the supply tray 16. The control unit 29 may determine the presence or absence of the document M0 based on the imaging data D1 or may determine the presence or absence of the document M0 based on a sensor that detects the document M0 on the supply tray 16. When determining in step S18 that the document M0 is present, the control unit 29 returns the processing to step S12. In this case, the control unit 29 starts conveying the next document M0. When determining in step S18 that the document M0 is absent, the control unit 29 ends the reading processing.

In step S17, the control unit 29 stops the conveyance of the document M0. The control unit 29 stops the rotation of the supply roller 21. Accordingly, the likelihood that the bound document M0 enters the housing 14 is reduced. When the conveyance of the document M0 is stopped, the control unit 29 ends the reading processing.

### Action and effects of the embodiment

Subsequently, action and effects of the embodiment explained above are explained.

(1) The control unit 29 analyzes the imaging data D1 to thereby determine whether the uppermost document M0 is the document M0 bound with another document M0. When determining that the uppermost document M0 is the document M0 bound with the other document M0, the control unit 29 stops the supply roller 21. With the configuration explained above, the conveyance device 12 determines, based on the imaging data D1, whether the uppermost document M0 is the document M0 bound with the other document M0. Accordingly, the conveyance device 12 can accurately determine the bound document M0.

(2) The control unit 29 analyzes the imaging data D1 to thereby detect the determination line L0 indicating the edge of the second document M2. When the gradient of the determination line L0 exceeds the threshold D2, the control unit 29 stops the supply roller 21. When the first document M1 and the second document M2 are bound, the second document M2 is pulled by the first document M1 as the supply roller 21 conveys the first document M1. As a result, the second document M2 sometimes tilts. With the configuration explained above, the conveyance device 12 can determine, based on the tilt of the second document M2, whether the first document M1 is the document M0 bound with the second document M2.

(3) The control unit 29 analyzes the imaging data D1 to thereby detect the shadow S0 located between the first document M1 and the second document M2. When detecting the shadow S0, the control unit 29 stops the supply roller 21. When the first document M1 and the second document M2 are bound, the second document M2 is pulled by the first document M1 as the supply roller 21 conveys the first document M1. As a result, a shadow is sometimes formed between the first document M1 and the second document M2. With the configuration explained above, the conveyance device 12 can determine, based on the shadow between the first document M1 and the second document M2, whether the first document M1 is the document M0 bound with the second document M2.

(4) The conveyance device 12 includes the irradiation unit 27 that emits light toward the supply tray 16. With the configuration explained above, the shadow S0 formed between the first document M1 and the second document M2 is emphasized by the irradiation unit 27. For that reason, the conveyance device 12 can easily determine, based on the shadow S0 between the first document M1 and the second document M2, whether the first document M1 is the document M0 bound with the second document M2.

(5) The conveyance device 12 includes the imaging unit 24 located to face the supply tray 16. With the configuration explained above, the conveyance device 12 can easily acquire the imaging data D1 suitable for the analysis.

(6) The imaging unit 24 is configured to be capable of adjusting the position thereof. With the configuration explained above, the conveyance device 12 can easily acquire the imaging data D1 suitable for the analysis by adjusting the position of the imaging unit 24.

(7) The control unit 29 analyzes the imaging data D1 to thereby detect the determination line L0 indicating the edge of the second document M2. The control unit 29 analyzes the imaging data D1 to thereby detect the shadow S0 located between the first document M1 and the second document M2. When the gradient of the determination line L0 exceeds the threshold D2 and the shadow S0 is detected, the control unit 29 stops the supply roller 21. When the first document M1 and the second document M2 are bound, the second document M2 is pulled by the first document M1 as the supply roller 21 conveys the first document M1. As a result, the second document M2 sometimes tilts. When the second document M2 is pulled by the first document M1, the shadow S0 is sometimes formed between the first document M1 and the second document M2. With the configuration explained above, the conveyance device 12 can determine, based on the gradient of the determination line L0 and the shadow S0, whether the first document M1 is the document M0 bound with the second document M2.

(8) The control unit 29 analyzes the imaging data D1 by causing the model D4 to output a determination value based on the imaging data D1. The control unit 29 determines, based on the determination value, whether the uppermost document M0 is the document M0 bound with another document M0. With the configuration explained above, the conveyance device 12 can accurately determine the bound document M0 based on the machine-learned model D4.

### Modifications

The embodiment explained above can be implemented by being modified as explained below. The embodiment explained above and the following modifications can be implemented in combination within a range where no technical contradictions occur.

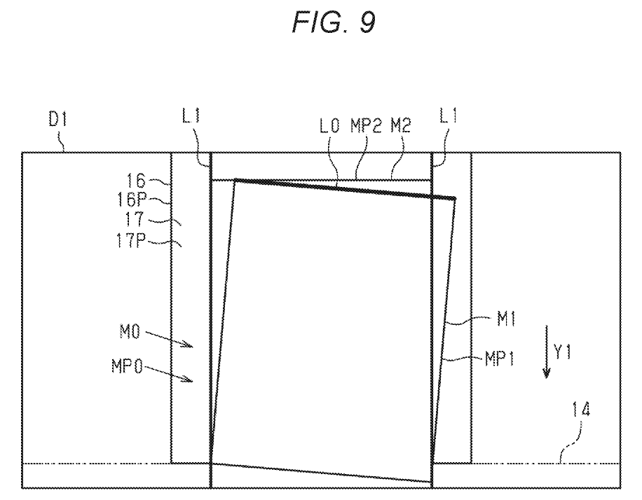

As illustrated in FIG. 9, the determination line L0 may be a line indicating the edge of the first document M1. In this modification, the determination line L0 is a line indicating an edge of the trailing end portion of the first document M1. The determination line L0 may be a line indicating the edge of the leading end portion of the first document M1. When the leading ends of the first document M1 and the second document M2 are bound, the first document M1 tilts as being conveyed. In an example illustrated in FIG. 9, corner portions of the first document M1 and the second document M2 are bound. In this case, the first document M1 tilts such that an unbound corner of two corners located at the leading end precedes a bound corner. For that reason, the control unit 29 can determine, based on the tilt of the first document M1, that the first document M1 is the bound document M0.

The control unit 29 detects the determination line L0 as in the embodiment explained above. In this modification, the control unit 29 detects the determination line L0 by identifying the first document M1 and the second document M2. The control unit 29 calculates the gradient of the determination line L0 as in the embodiment explained above. The control unit 29 compares the gradient of the determination line L0 and the threshold D2 as in the embodiment explained above. When the gradient of the determination line L0 exceeds the threshold D2, the control unit 29 determines that the first document M1 is the bound document M0.

As illustrated in FIG. 9, the control unit 29 may determine, based on two specific lines L1, whether the first document M1 is the bound document M0. The specific line L1 is a straight line overlapping the edge of the second document M2. Specifically, the two specific lines L1 are straight lines respectively overlapping both ends defining the width of the second document M2. The specific line L1 is a straight line extending in the conveyance direction Y1. The specific line L1 is indicated by pixels linearly arranged along the edge of the second document M2 in the imaging data D1. The control unit 29 calculates the specific line L1 based on the edge of the second document M2.

When the first document M1 protrudes from a region between the two specific lines L1, the control unit 29 determines that the first document M1 is the bound document M0. When the leading ends of the first document M1 and the second document M2 are bound, the first document M1 tilts as being conveyed. As a result, when the first document M1 is bound with the second document M2, the first document M1 protrudes from the region between the two specific lines L1.

The control unit 29 may turn on the irradiation unit 27 when determining that the adjustment of the imaging unit 24 is necessary in the adjustment processing. Depending on an installation environment of the reading apparatus 11, clear imaging data D1 is sometimes obtained without turning on the irradiation unit 27. In this case, according to this modification, the control unit 29 can execute the reading processing without turning on the irradiation unit 27. Accordingly, the power consumption of the reading apparatus 11 is reduced.

The control unit 29 may determine the presence or absence of stapling in the document M0 by analyzing the imaging data D1. When there is a staple, control unit 29 may determine that document M0 is bound.

The conveyance device 12 may be applied to not only the reading apparatus 11 but also a recording apparatus that records an image on a sheet, a film, or the like. The recording apparatus may be, for example, an inkjet printer.

### Technical ideas

Technical ideas grasped from the embodiment and the modifications explained above and action effects of the technical ideas are described below.

(A) A conveyance device includes: a supply tray on which a plurality of documents are stacked; a supply roller configured to come into contact with an uppermost document among the plurality of documents stacked on the supply tray; a separation roller facing the supply roller and configured to separate, one by one, the plurality of documents stacked on the supply tray; and a control unit configured to acquire imaging data obtained by imaging the uppermost document stacked on the supply tray. The control unit analyzes the imaging data to thereby determine whether the uppermost document is a document bound with another document and, when determining that the uppermost document is the document bound with another document, stops the supply roller. With the configuration explained above, the conveyance device determines, based on the imaging data, whether the uppermost document is a document bound with another document. Accordingly, the conveyance device can accurately determine the bound document.

(B) In the conveyance device explained above, the imaging data may be data obtained by imaging a first document, which is the uppermost document, and a second document, which is a document next to the first document among the plurality of documents, and the control unit may detect a determination line indicating an edge of the second document by analyzing the imaging data and stop the supply roller when an gradient of the determination line exceeds a threshold. When the first document and the second document are bound, the second document is pulled by the first document as the supply roller conveys the first document. As a result, the second document sometimes tilts. With the configuration explained above, the conveyance device can determine, based on the tilt of the second document, whether the first document is a document bound with the second document.

(C) In the conveyance device explained above, the imaging data may be data obtained by imaging a first document, which is the uppermost document, and a second document, which is a document next to the first document among the plurality of documents, and the control unit may detect a shadow located between the first document and the second document by analyzing the imaging data and, when the shadow is detected, stop the supply roller. When the first document and the second document are bound, the second document is pulled by the first document as the supply roller conveys the first document. As a result, a shadow is sometimes formed between the first document and the second document. With the configuration explained above, the conveyance device can determine, based on the shadow between the first document and the second document, whether the first document is a document bound with the second document.

(D) The conveyance device explained above may include an irradiation unit configured to emit light toward the supply tray. With the configuration explained above, the shadow formed between the first document and the second document is emphasized by the irradiation unit. For that reason, the conveyance device can easily determine, based on the shadow between the first document and the second document, whether the first document is a document bound with the second document based on the shadow between the first document and the second document.

(E) The conveyance device explained above may include an imaging unit located to face the supply tray, and the control unit may acquire the imaging data from the imaging unit. With the configuration explained above, the conveyance device can easily acquire imaging data suitable for the analysis.

(F) In the conveyance device explained above, the imaging unit may be configured to be capable of adjust a position thereof. With the configuration explained above, the conveyance device can easily acquire imaging data suitable for the analysis by adjusting the position of the imaging unit.

(G) In the conveyance device explained above, the imaging data may be data obtained by imaging a first document, which is the uppermost document, and a second document, which is a document next to the first document among the plurality of documents, and the control unit may detect a determination line indicating an edge of the second document by analyzing the imaging data, detect a shadow located between the first document and the second document by analyzing the imaging data and, when an gradient of the determination line exceeds a threshold and the shadow is detected, stop the supply roller. When the first document and the second document are bound, the second document is pulled by the first document as the supply roller conveys the first document. As a result, the second document sometimes tilts. When the second document is pulled by the first document, a shadow is sometimes formed between the first document and the second document. With the configuration explained above, the conveyance device can determine, based on the determination line and the shadow between the first document and the second document, whether the first document is a document bound with the second document.

(H) The conveyance device may include a storage unit configured to store a machine-learned model configured to output a determination value indicating, based on the imaging data, whether the uppermost document is a document bound with another document, and the control unit may analyze the imaging data by causing the model to output the determination value based on the imaging data and determine, based on the determination value, whether the uppermost document is a document bound with another document. With the configuration explained above, the conveyance device can accurately determine the bound document based on the machine-learned model.

(I) A reading apparatus includes: the conveyance device described above; and a reading unit configured to read the plurality of documents. With the configuration explained above, the same effects as the effects of the conveyance device explained above can be obtained.

What is claimed is:

1. A conveyance device comprising:
a supply tray on which a plurality of documents are stacked;
a supply roller configured to come into contact with an uppermost document among the plurality of documents stacked on the supply tray;
a separation roller facing the supply roller and configured to separate, one by one, the plurality of documents stacked on the supply tray; and
a control unit configured to acquire imaging data obtained by imaging the uppermost document stacked on the supply tray, wherein
the control unit analyzes the imaging data to thereby determine whether the uppermost document is a document bound with another document and, when determining that the uppermost document is the document bound with another document, stops the supply roller.

2. The conveyance device according to claim 1, wherein
the imaging data is data obtained by imaging a first document, which is the uppermost document, and a second document, which is a document next to the first document among the plurality of documents, and
the control unit detects a determination line indicating an edge of the second document by analyzing the imaging data and stops the supply roller when an gradient of the determination line exceeds a threshold.

3. The conveyance device according to claim 1, wherein
the imaging data is data obtained by imaging a first document, which is the uppermost document, and a second document, which is a document next to the first document among the plurality of documents, and
the control unit detects a shadow located between the first document and the second document by analyzing the imaging data and, when the shadow is detected, stops the supply roller.

4. The conveyance device according to claim 3, further comprising an irradiation unit configured to emit light toward the supply tray.

5. The convey apparatus according to claim 1, further comprising an imaging unit located to face the supply tray, wherein
the control unit acquires the imaging data from the imaging unit.

6. The conveyance apparatus according to claim 5, wherein the imaging unit is configured to be capable of adjust a position thereof.

7. The conveyance device according to claim 1, wherein
the imaging data is data obtained by imaging a first document, which is the uppermost document, and a second document, which is a document next to the first document among the plurality of documents, and
the control unit detects a determination line indicating an edge of the second document by analyzing the imaging data, detects a shadow located between the first document and the second document by analyzing the imaging data and, when an gradient of the determination line exceeds a threshold and the shadow is detected, stops the supply roller.

8. The conveyance apparatus according to claim 1, further comprising a storage unit configured to store a machine-learned model configured to output a determination value indicating, based on the imaging data, whether the uppermost document is a document bound with another document, and
the control unit analyzes the imaging data by causing the model to output the determination value based on the imaging data and determines, based on the determination value, whether the uppermost document is a document bound with another document.

9. A reading apparatus comprising:
the conveyance device according to claim 1; and
a reading unit configured to read the plurality of documents.
